(19) United States
(12) Patent Application Publication
(10) Pub. No.: US 2016/0162905 A1
(43) Pub. Date: Jun. 9, 2016

(54) METHOD AND APPARATUS FOR LINKING DEVICE APPLICATIONS TO A CUSTOMER SERVICE INTERFACE

(71) Applicants: Tajinder SINGH, Campbell, CA (US); Michael MONEGAN, Campbell, CA (US); 24/7 CUSTOMER, INC., Campbell, CA (US)

(72) Inventors: Tajinder SINGH, Santa Clara, CA (US); Michael MONEGAN, Los Osos, CA (US)

(21) Appl. No.: 14/907,264

(22) PCT Filed: Jul. 22, 2014
(86) PCT No.: PCT/US14/47602

§ 371 Date: Jan. 22, 2016

Related U.S. Application Data
(60) Provisional application No. 61/857,142, filed on Jul. 22, 2013.

(51) Int. Cl. G06Q 30/00; H04L 29/06

(52) U.S. Cl. CPC G06Q 30/016; H04L 63/0876; G06Q 30/0185

(57) ABSTRACT

A device application is linked to a customer service interface. Information related to a user and to one or more user interactions is stored with an application associated with a user device. The information related to the user and the one or more user interactions configures an interaction context. A request to communicate with a customer service interface is received from the user during an on-going user interaction with the application. An authentication of the user is performed upon receiving the user request. The interaction context is provided to the customer service interface upon authenticating the user. The authentication of the user and the providing of the interaction context facilitate a seamless continuation of the on-going user interaction from the application associated with the user device to the customer service interface.

### CROSS-REFERENCE TO RELATED APPLICATIONS

This application is a 35 U.S.C. §371 National Stage application of PCT/US2014/047602, filed on Jul. 22, 2014, which claims the benefit of U.S. provisional patent application Ser. No. 61/857,142, filed Jul. 22, 2013, which applications are incorporated herein in their entirety by this reference thereto.

### FIELD

The invention relates to device applications and, more particularly, to linking of device applications to a customer service interface.

### BACKGROUND

Electronic devices, such as mobile phones, laptops, and the like, include a number of applications (for example, software applications) designed to assist users of the electronic devices in performing various functions. For example, electronic devices may include applications related to banking, travel reservations, social networking, news reports, sports updates, weather forecasts, and the like. In various example scenarios, the applications may include built-in features for addressing user queries and/or complaints. For example, an application may include a frequently asked questions (FAQ) section, to enable a user to find an answer to a query or resolve a concern without requiring external assistance, e.g. assistance in form of an interaction with a customer service representative.

However, occasionally, the features in an application may be incapable of addressing a user's concern adequately and the user may need to contact a customer support center. In such cases, the user has to restart the concern resolution process, which can be frustrating for the user, as the user has to re-identify/re-authenticate himself and provide contextual information again, even though he might have provided such information to the application in the electronic device. This may reduce a quality of customer experience leading to an increase in customer frustration and customer churn.

### SUMMARY

Various methods and apparatuses for linking device applications to customer service interfaces are disclosed. In an embodiment, a method for linking a device application to a customer service interface is disclosed. The method includes storing, by an apparatus, information related to a user and to one or more user interactions with an application associated with a user device. The information related to the user and to the one or more user interactions configures an interaction context.

Further, the method includes receiving, by the apparatus, a request to communicate with a customer service interface from the user during an on-going user interaction with the application. An authentication of the user is performed, by the apparatus, upon receiving the request.

Furthermore, the method includes providing, by the apparatus, the interaction context to the customer service interface upon authenticating the user. The authentication of the user and the providing of the interaction context facilitate a seamless continuation of the on-going user interaction from the application associated with the user device to the customer service interface.

In another embodiment, the apparatus for linking a device application to a customer service interface is disclosed. The apparatus includes at least one processor and a memory. The memory is adapted to store machine executable instructions therein, that when executed by the at least one processor, cause the apparatus to store information related to a user and to one or more user interactions with an application associated with a user device. The information related to the user and to the one or more user interactions configures an interaction context. Further, the apparatus is caused to receive a request to communicate with a customer service interface from the user during an on-going user interaction with the application. The apparatus is caused to perform an authentication of the user upon receiving the request.

Furthermore, the apparatus is caused to provide the interaction context to the customer service interface upon authenticating the user. The authentication of the user and the providing of the interaction context facilitate a seamless continuation of the on-going user interaction from the application in the user device to the customer service interface.

### DESCRIPTION OF THE FIGURES

FIG. 1 is a schematic diagram showing an example environment in which various embodiments of the invention may be practiced;

FIG. 2 is a block diagram of an example apparatus configured to link a device application to a customer service interface in accordance with an embodiment of the invention;

FIG. 3 is a first screenshot of a device screen of a user device displaying an application for illustrating an on-going user interaction in accordance with an example embodiment of the invention;

FIG. 4 is a second screenshot of the device screen of the user device for illustrating an authentication of the user using an authentication code in accordance with an example embodiment of the invention;

FIG. 5 is a third screenshot of the device screen of the user device for illustrating an authentication of the user using a passphrase in accordance with an example embodiment of the invention;

FIG. 6 is a fourth screenshot of the device screen of the user device for illustrating an authentication of the user using a dialed number identification service (DNIS) number in accordance with an example embodiment of the invention;

FIG. 7 is a schematic diagram showing an example linking of a device application to a customer service interface in accordance with an embodiment of the invention; and

FIG. 8 is a flow diagram of a method for linking a device application to a customer service interface in accordance with an embodiment of the invention.

### DESCRIPTION

The term ‘device applications’ as used herein refers to software applications in electronic devices, such as mobile phones, personal computers (PC), laptops, smartphones, tablet PCs and the like. Examples of the device applications may include, but are not limited to, applications facilitating financial transactions (for example, banking applications), applications facilitating travel reservations (for example, a flight booking applications), bill payment applications (for example, mobile or credit-card bill payment applications), and the like. The device applications may be native or non-native to the corresponding device.

The term ‘native mobile applications’ as used herein refer to platform specific applications residing in mobile devices, such as mobile phones, laptops, smartphones, tablet PCs, and the like. A native mobile application is configured to interact with features and applications associated with a corresponding platform. Accordingly, program code for a native mobile application is written in a programming language, which is specific to the corresponding platform. Examples of such programming languages may include ‘Objective C’ for IOS platform, ‘JAVA’ for Android™ platform, ‘Visual C++’ for Windows® Mobile platform, and the like. The native mobile application may be pre-packaged within the mobile device during sale or may be downloaded from a public or private application store and subsequently installed on the mobile device. It is noted that a device application is also interchangeably referred to herein as ‘application’ or ‘application associated with electronic device.’

The term ‘customer service interface’ as used herein refers to a customer service representative (or an agent) and/or an interactive voice response (IVR) facility at the customer service center. It is noted that though embodiments disclosed for customer service interface herein refer to a telephony interface, the customer service interface may be implemented using data interfaces, or in some embodiments, data interfaces may also used in conjunction with a telephony interface.

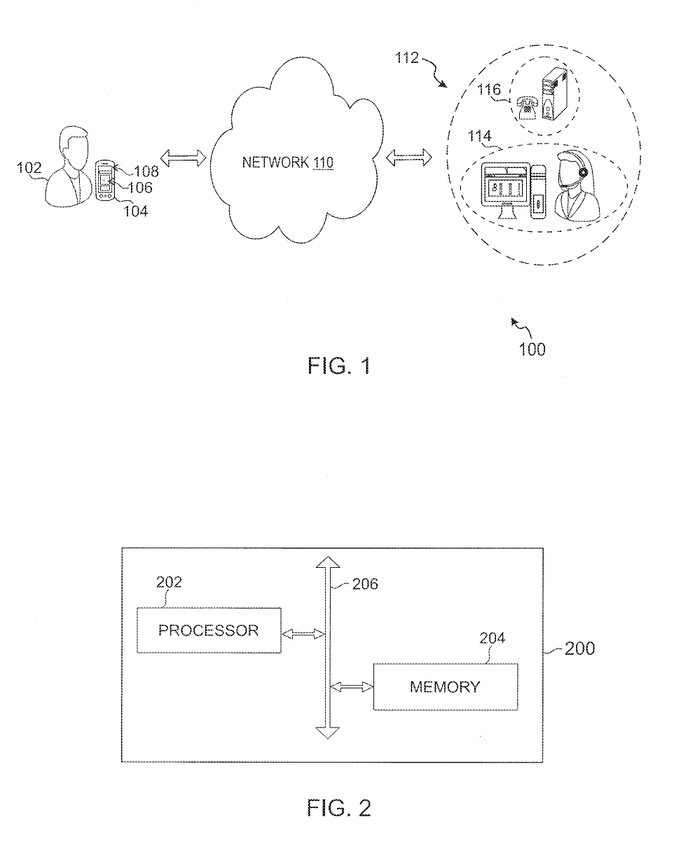

Various embodiments of the invention provide methods and apparatuses for linking device applications (like native mobile applications) to a customer service interface. More specifically, the methods and apparatuses disclosed herein enable users to traverse a user experience that is initiated within a device application to a self-service or assisted technology, for example an IVR interface, or even to a customer service representative without needing to restart the resolution process. The various methods and apparatuses for linking device applications to a customer service interface are described herein with reference to FIGS. 1 to 8.

FIG. 1 is a schematic diagram showing an example environment 100 in which various embodiments of the invention may be practiced. The environment 100 depicts a user 102 associated with a smartphone 104. It is noted that the user 102 is depicted to be associated with a smartphone 104 for illustration purposes and that user 102 may be associated with any other electronic device (such as laptop, a tablet PC etc.). The smartphone 104 includes a plurality of device applications, including but not limited to, native mobile applications, Web-based applications, and hybrid applications. For example, the smartphone 104 may include applications related to banking, travel reservations, social networking, news reports, sports updates, weather forecasts, and the like. One such device application 106 is depicted to be displayed in a screen 108 associated with the smartphone 104. The device application 106 may be pre-packaged within the smartphone 104 during sale or may be downloaded from a private or a public application store over a network 110. Examples of the network 110 may include wired networks, wireless networks or combinations thereof. Examples of wired networks may include Ethernet, local area network (LAN), fiber-optic cable network, and the like. Examples of wireless network may include cellular networks such as GSM/3G/4G/CDMA networks, wireless LAN, blue-tooth or Zigbee networks, and the like. An example of a combination of wired and wireless networks may include the Internet.

In an example scenario, the device application 106 includes built-in features for addressing user queries and/or complaints. For example, the device application 106 may include a frequently asked questions (FAQ) section, to enable a user to find an answer to a query or resolve a concern without requiring external assistance (for example, assistance in form of an interaction with a customer service representative). However, occasionally, the features in the device application 106 may be incapable of addressing a user's concern adequately and the user may need to contact a customer support center over the network 110. One such customer support center 112 is depicted in environment 100. The customer support center 112 is exemplarily depicted to include a human agent 114 and an interactive voice response (IVR) system 116. The human agent 114 and/or the IVR system 116 constitute the customer service interface corresponding to the customer support center 112. It is understood that the customer support center 112 is depicted to include one human agent and one IVR system for illustration purposes and that the customer support center 112 may include a plurality of such human agents and IVR systems.

If the user is unable to address a concern adequately using in-built self-assistance features in the device application 106, the user 102 may seek interaction with one of a human agent 114 and the IVR system 116. In such a case, the user 102 has to restart the concern resolution process, which may be frustrating, as the user 102 has to re-identify/re-authenticate his credentials and provide contextual information again even though he/she might have provided such information to the device application 106 in the smartphone 104. This may reduce a quality of customer experience leading to an increase in customer frustration and customer churn. Accordingly, the device applications, such as the device application 106 must be linked to the customer service interface to preclude an event where a user, such as the user 102, has to re-identify/re-authenticate user credentials and restart the resolution process. An apparatus configured to link a device application to a customer service interface is explained with reference to FIG. 2.

FIG. 2 is a block diagram of an example apparatus 200 configured to link a device application to a customer service interface in accordance with an embodiment of the invention. In an embodiment of the invention, the apparatus 200 is a part of a system configured to facilitate interaction between users and customer service interfaces. The apparatus 200 may be embodied as a Web server communicably associated over a Web medium with enterprise device applications residing in user devices, such as the smartphone 104 of FIG. 1. Further, the apparatus 200 may be communicably associated with customer service interfaces corresponding to the enterprises associated with the device applications. In an embodiment of the invention, the apparatus 200 may be any machine capable of executing a set of instructions (sequential and/or otherwise) so as to link a device application to a customer service interface.

The apparatus 200 includes at least one processor, such as the processor 202 and a memory 204. It is noted that though the apparatus 200 is depicted to include only one processor, the apparatus 200 may include more number of processors therein. In an embodiment of the invention, the processor 202 and the memory 204 are configured to communicate with each other via or through a bus 206. Examples of the bus 206 may include, but are not limited to, a data bus, an address bus, a control bus, and the like. The bus 206 may be, for example, a serial bus, a bi-directional bus or a unidirectional bus.

The memory 204 is capable of storing machine executable instructions. Further, the processor 202 is capable of executing the stored machine executable instructions. The processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment of the invention, the processor 202 is embodied as an executor of software instructions, wherein the instructions may specifically configure the processor 202 to perform the algorithms and/or operations described herein when the instructions are executed. The processor 202 may include, among other things, a clock, an arithmetic logic unit (ALU) and logic gates configured to support an operation of the processor 202. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

In an embodiment of the invention, the processor 202 is configured to, with the content of the memory 204, cause the apparatus 200 to store information related to a user and to one or more user interactions with an application associated with a user device. More specifically, the memory 204 of the apparatus 200 may be configured to store information related to the user and to the one or more user interactions with the application associated with the user device. As explained with reference to FIG. 1, a user device (such as the smartphone 104 explained with reference to FIG. 1) may be associated with (or more specifically, may include) a plurality of device applications, such as native mobile applications, Web-based applications, hybrid applications and the like. A user may interact with such applications to perform various functions, such as those related to banking, retail purchases, travel reservations, networking and the like. In an embodiment, the apparatus 200 may be caused to store the information related to user's interaction with an application on the user device. For example, the information related to the one or more user interactions with the application may include an interaction history corresponding to one or more past interactions between the user and the application, a last user transaction associated with the application and the like. In an illustrative example, if the application corresponds to a retail enterprise associated with a sale of a plurality of products, then user's past interaction history may include information related to user's past purchases, types of products purchased, frequency of purchase and the like. Additionally, a last user transaction on the application may also be stored as information related to user interaction with the application. In addition to storing the information related to user's interaction with the application, the apparatus 200 is caused to store information related to the user. For example, the apparatus 200 may be caused to store user's personal information, such as name, mailing address, contact details, email accounts, social networking accounts, a number of user devices associated with the user, a type of the user devices associated with the user, user's device preferences, and the like. Further, the apparatus 200 may be caused to store user authentication information associated with the application as information related to the user. For example, the user may login to the application using a login name and password; a unique authentication code (for example, code including three to five digits); a unique passphrase; a unique gesture; biometric data and/or a recorded audio tune. The apparatus 200 is caused to store such authentication information of the user as information related to the user. In an embodiment, the information related to the user and to the one or more user interactions stored in the memory 204 of the apparatus 200 configures an interaction context (or more specifically, serve as contextual information for current and subsequent user interactions with the application).

In an embodiment of the invention, the processor 202 is configured to, with the content of the memory 204, cause the apparatus 200 to receive a request to communicate with a customer service interface from the user during an on-going user interaction with the application. As explained with reference to FIG. 1, applications in a user device (also referred to herein as device applications) include in-built features for assisting a user to obtain answer to a query or to resolve a concern without requiring external assistance. In an embodiment, the application is configured to include one or more such self-assistance features associated with resolution of common issues encountered during interaction with the application. Examples of such self-assistance features include, but are not limited to online support forums, self-help widgets and FAQ sections. However, occasionally, such self-assistance features are unable to adequately address user concerns and the user may seek assistance from a customer support center (such as the customer support center 112) of FIG. 1. More specifically, the user, upon being unable to resolve a concern during an on-going interaction with the application, may seek to communicate with a customer service interface, such as a human agent interface or an interactive voice response (IVR) based interface (which are referred to herein as a customer service interface) at the customer support center. The application may display a customer support clickable button (or an icon, for example a ‘Contact Us’ button), which upon being accessed may enable the user to transmit the request for communicating with the customer service interface. In an embodiment of the invention, the application may display a hyperlinked toll-free number for enabling the user to transmit the request for communicating with the customer service interface. The apparatus 200 may be caused to receive the request for communicating with the customer service interface over a network, such as the network 110 explained with reference to FIG. 1.

In an embodiment of the invention, the processor 202 is configured to, with the content of the memory 204, cause the apparatus 200 to perform an authentication of the user upon receiving the request. More specifically, the request for communicating with the customer service interface may be received by the apparatus 200, which may then initiate authentication of the user. In an embodiment, the apparatus 200 is caused to perform authentication of the user based on at least one of (1) an authentication code; (2) a passphrase; (3) a dialed number identification service (DNIS) number; (4) an outpulsed code, and (5) an embedded session initiation protocol (SIP) softphone. The performing of the authentication is further explained below.

The apparatus 200 is caused to request an authentication code from the user. For example, upon clicking the customer support button or upon accessing the toll-free number by the user, a request for communicating with the customer service interface may be sent to the apparatus 200 (for example, using a secure Web service over a network, such as the network 110 explained with reference to FIG. 1). The apparatus 200 upon receiving such a request may be caused to display a pop-up widget on the application including text such as ‘Enter authentication code’ followed by a numeral entry field to receive the authentication code as input from the user. In an embodiment of the invention, the apparatus 200 is caused to receive the authentication code provided by the user using the secure Web service. Further, the apparatus 200 is caused to compare the authentication code to stored user authentication information for a match.

As explained above, the apparatus 200 is caused to store information related to the user, such as the user authentication information including login name and password, authentication code and/or passphrase associated with accessing the application. Accordingly, upon provisioning of the authentication code by the user, the apparatus 200 may be caused to verify a presence of match with the authentication code stored in the memory 204. If the presence of the match is verified, then the user authentication is determined to be a success. However, if the authentication code provided by the user does not match the stored user authentication information, then the user authentication is determined to be a failure. In such a scenario, the apparatus 200 is caused to request the user to provide the authentication code again. The request to the user for the authentication code may be performed repeatedly until one of: a determination of the user authentication as a success, a time-based expiration of the authentication code is reached, or an expiration of a number of trial attempts is achieved. In an embodiment of the invention, the number of trial attempts afforded to the user may be determined by the apparatus 200 based on empirical data (or statistical information) and may be manually configured or automatically set by the apparatus 200.

Alternatively, the apparatus 200 is caused to request a passphrase from the user upon receiving the request, for performing authentication of the user. For example, upon clicking the customer support button or accessing the toll-free number, a request for communicating with the customer service interface may be sent to the apparatus 200 using the secure Web service. The apparatus 200 upon receiving such a request may be caused to display a pop-up widget on the application including text such as ‘Enter passphrase’ followed by a text entry field to receive the passphrase as input from the user. In an embodiment of the invention, the apparatus 200 is caused to receive the passphrase provided by the user using the secure Web service. Further, the apparatus 200 is caused to compare the passphrase to stored user authentication information for a match.

As explained above, the apparatus 200 is caused to store information related to the user, such as the user authentication information including login name and password, authentication code and/or passphrase associated with accessing the application. Accordingly, upon provisioning of the passphrase by the user, the apparatus 200 may be caused to verify a presence of match with the passphrase stored in the memory 204. If the presence of the match is verified, then the user authentication is determined to be a success. However, if the passphrase provided by the user does not match the stored user authentication information, then the user authentication is determined to be a failure. In such a scenario, the apparatus 200 may be caused to request the user to provide the passphrase again as explained above with reference to the authentication code based user authentication.

In an embodiment of the invention, the apparatus 200 is caused to provide a unique dialed number identification service (DNIS) number from among a pool of unique DNIS numbers to the user upon receiving the request from the user. In an embodiment, the provisioning of the DNIS number to the user on the application may be facilitated using the secure Web service. In an example embodiment, the DNIS number may be a ten-digit number. It is noted that a large pool of unique DNIS numbers ensures that a DNIS number is never used for two calls at the same time. Such a feature may be achieved by ensuring that a total number of DNIS numbers in pool of DNIS numbers is greater than the number of maximum simultaneous calls that may need to be handled at any given instance of time. Accordingly, DNIS numbers may be recycled without being reused at the same time for another call. In an embodiment, the selection of the DNIS number from among the pool of DNIS numbers is performed in real time by the customer service interface, a telecommunications provider associated with the customer service interface, or an external service allocating traffic across multiple similar instances of a customer service interface. The selected DNIS number is then provided to the apparatus 200 for subsequent provision to the user.

In an embodiment of the invention, a dialing of the unique DNIS number by the user is configured to assist in uniquely identifying the user and hence eliminate the need to re-authenticate the user prior to the end of a configurable expiration period, on the basis that the user device must still be in the control of the same user who authenticated themselves to the device application. If a user accidentally dials a DNIS after the end of the configurable expiration period, the apparatus 200 in assistance with the customer service interface may be caused to return an error because no request corresponding to that DNIS number was recently made for that user over the network. Such a configuration may prevent accidental and malicious callers re-using a DNIS number.

In an embodiment of the invention, the apparatus 200 is caused to receive an audio signal including dual tone multi-frequency (DTMF) corresponding to an outpulsed code. The outpulsed code is configured by dialing a phone number corresponding to the customer service interface appended with a unique authentication code. Further, digits corresponding to the phone number and the unique authentication code are separated by one or more special characters while dialing the phone number appended with the unique combination code. For example, upon receiving a request for communicating with the customer service interface, a phone number such as for example a toll free number corresponding to the customer service interface may be provisioned to the user. The user may be requested to append the unique authentication code to the phone number, while dialing. Moreover, the user may be requested to include special characters, such as a comma (‘,’), as substitutes for pauses in-between the digits while dialing the phone number appended with the unique combination code. Upon dialing such a combination of digits a DTMF corresponding to the outpulsed code may be transmitted to the apparatus 200.

The apparatus 200 is configured to receive the audio signal including DTMF corresponding to the outpulsed code. The apparatus 200 is further caused to compare the unique authentication code in the audio signal to the user authentication information for a match. In an embodiment, the user is authenticated upon determining a presence of the match between the unique authentication code and the user authentication information.

In an embodiment of the invention, the apparatus 200 is caused to provide a phone number corresponding to the customer service interface to the user on the application upon receiving the request for communication with the customer service interface. The apparatus 200 is further caused to receive a voice over Internet protocol (VOIP) call from the user device based on the phone number. In an embodiment, VOIP call credentials, such as a session initiation protocol (SIP) address or a custom SIP header may be allocated from a logical pool, similar to DNIS number allocation as described above. In this embodiment, a dialing of the phone number using these VOIP call credentials by the user is configured to facilitate authentication of the user through association of the user with the VOIP call credentials. The user device includes an embedded SIP enabled softphone, which is communicably associated with the application to facilitate VOIP calling of the phone number. The SIP enabled soft phone may be embedded (for example in form of a native software development kit (SDK)) within the user device, such as the smartphone 104 explained with reference to FIG. 1, or, the SIP enabled softphone may be externally associated with the user device. In an embodiment of the invention, the SIP enabled softphone may be called upon by the application to generate the VoIP call using a trusted network over a communication channel. Examples for the communication channel may include, but are not limited to, a mobile communication channel, Wi-Fi channel, and the like. It is noted that VOIP calling using the SIP enabled softphone may require trusted network connection or a high bandwidth data channel and as such a bandwidth availability of the channel may be ascertained prior to initiating the VOIP call for facilitating user authentication.

In some embodiments of the invention, the apparatus 200 is caused to perform user authentication by performing at least one of a biometric data based authentication, a gesture based authentication and an audio based authentication. In some embodiments, the authentication mechanisms, such as those using rotating DNIS numbers, authentication codes, passphrases, outpulse codes, embedded SIP softphones, biometric data based authentication, gesture based authentication and audio based authentication may be used separately or in conjunction with each other to authenticate the user. In an example embodiment, the processor 202 is configured to, with the content of the memory 204, cause the apparatus 200 to facilitate communication between the user and the customer service interface upon authenticating the user.

In an embodiment of the invention, the communication between the user and the customer service interface may be facilitated using the secure Web service over a network, such as the network 110 explained with reference to FIG. 1. In an illustrative example, a user upon being unable to resolve a concern using in-built self-assistance features in the application may request communication with a customer service interface by accessing a customer support icon or clicking on a hyperlinked toll-free number corresponding to the customer service interface. Upon accessing a customer support icon or clicking on a hyperlinked toll-free number, the apparatus 200 may receive the request and perform user authentication using one or more authentication mechanisms as explained above. Upon authenticating the user, the apparatus 200 may connect the user, for example using the same toll-free number, to the customer service interface, thereby facilitating communication between the user and the customer service interface.

In embodiments of the invention involving native device applications, facilitating communication between the user and the customer service interface may include provisioning, post user-authentication, a widget requesting user permission to allow interaction with a customer service interface. In another illustrative example, a pop-up window displaying a textual request for allowing interaction with a customer service interface may be provisioned to the user on the native device application. Exemplary scenarios may include provisioning, post user-authentication, and a communication providing the user with options to engage in an interaction with a customer service interface. For example, some users may prefer conducting the interactions over a voice call (i.e. a speech medium preference) whereas some customers may prefer to interact with customer service interfaces over chat (i.e. a messaging medium preference). Accordingly, the communication may be facilitated by conducting the interaction over a particular medium and/or device opted by the user.

For example, if the user opts for a voice interaction, then a pop-up window or a widget including text such as ‘Would you like our customer service representative to call you on your phone number ‘XX-XX-XXXXXX’ to discuss your requirements?’ may be provisioned to the user, thereby enabling the user to switch to opted interaction mode for customer service interactions. In another illustrative example, if the user opts a chat interaction, then chat interaction can be started. Such interaction may be initiated within the native app also. Accordingly, in some embodiments, the textual content in the communication may also suggest a day/time for scheduling the interaction. In an embodiment, the apparatus 200 is configured to receive the user response prior to facilitating communication between the user and the customer service interface.

In an embodiment of the invention, the processor 202 is configured to, with the content of the memory 204, cause the apparatus 200 to provide the interaction context to the customer service interface upon authenticating the user. More specifically, the apparatus 200 is caused to provide the interaction context to the customer service interface upon facilitating communication between the user and the customer service interface. At least one of the provisioning of the interaction context and subsequent communication between the user and the customer service interface is performed using a secure Web service over a communication network.

As explained above, the apparatus 200 is caused to store the interaction context, or more specifically, the information related to the user and to the one or more user interactions with the application. Upon authenticating the user, the apparatus 200 is caused to provide the interaction context to the customer service interface (for example, to the human agent interface or the IVR based interface). As a result of such authentication and the providing of the interaction context, the user does not have to provide details for self-identification (and/or authentication) and moreover, does not even to have to re-establish the context for continuing the interaction, thereby rendering the continuation of the on-going user interaction from the application in the user device to the customer service interface to be seamless.

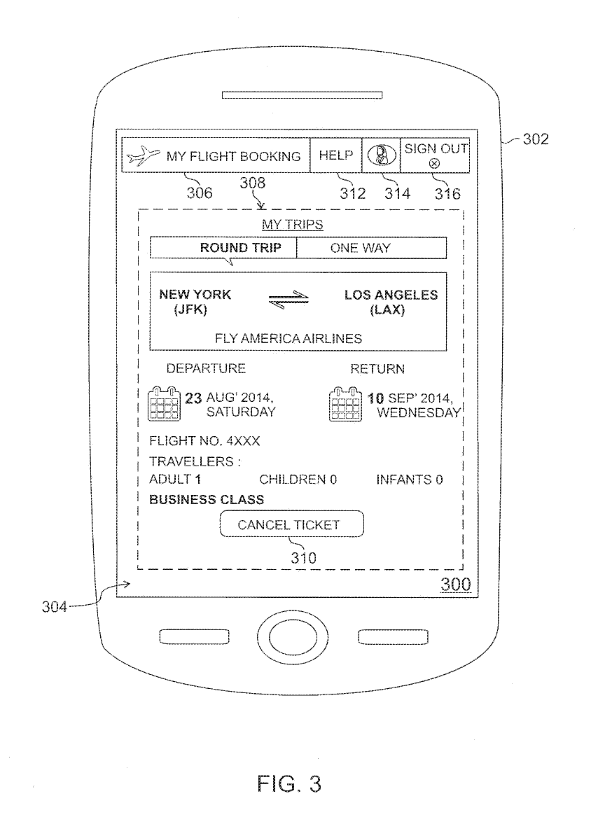

More specifically, the authentication and the providing of the interaction context link the application on the user device to the customer service interface, and such a linking of the application to the customer service interface facilitates seamless traversal of the user's experience from the application to the customer service interface. A user experience may thereby be improved and satisfaction quotient of the user be increased, leading to reduced user churn. The authentication of the user by the apparatus 200 for facilitating linking of the application to the customer service interface is further explained with reference to an illustrative example in conjunction with FIGS. 3 to 6.

FIG. 3 is a first screenshot of a device screen 300 of a user device 302 displaying an application 304 for illustrating an on-going user interaction in accordance with an example embodiment. The application 304 is depicted to be a native mobile application capable of assisting a user in making flight reservations. It is understood that the native mobile application is displayed herein for illustration purposes and that the user device 302 may include a plurality of applications facilitating various other functions as explained with reference to FIG. 2. It is further noted that a depiction of the user device 302 as a mobile phone may not be considered to be limiting. Indeed other electronic devices, like laptops, tablet PCs and the like may be utilized for interacting with device applications therein.

The application 304 displayed in the device screen 300 is depicted to include a title bar 306 displaying the name of the application 304 as ‘MY FLIGHT BOOKING’. Further, the first screenshot depicts a content section 308 displaying a label ‘MY TRIPS’ and a flight itinerary recently booked by the user. The flight itinerary corresponds to round trip journey between New York and Los Angeles destinations. The content section 308 is further depicted to display an airline name, travel dates, flight number, passenger details and the like. The content section 308 is also depicted to include a clickable button 310 displaying the text ‘CANCEL TICKET’ for enabling the user to cancel the displayed itinerary.

Further, the application 304 displayed in the device screen 300 is depicted to include a ‘HELP’ option 312 and a ‘SIGN OUT’ option 316. The ‘SIGN OUT’ option 316 enables the user to terminate access to the application 304. The ‘HELP’ option 312, upon being accessed by the user, provisions a list of frequently asked questions (FAQs) to the user. The list of FAQs may include questions and answers related to common enquiries, such as for example, enquiries related to baggage allowance, frequent flyer miles, terms of cancellation, travel insurance and the like.

In an example scenario, the user of the user device 302 may desire to re-schedule only a return leg of the journey proposed in the itinerary displayed on the device screen 300. Accordingly, the user may login to the application 304 (i.e. login into ‘MY FLIGHT BOOKING’) residing in the user device 302 by using user authentication information (such as for example, login details, authentication code and/or passphrase). Upon accessing the application 304, the user may seek assistance on re-scheduling a part of the journey, for example, by accessing the ‘HELP’ option 312.

Though the ‘HELP’ option 312 may include information related to canceling an itinerary and/or re-scheduling an itinerary, in some example scenarios, it may not include information related to re-scheduling only a part of the journey. The user may then access a customer support option 314 displayed on the device screen 300 in order to communicate with a customer service interface, such as a human agent interface or an IVR based interface. It is noted that the customer support option 314 is depicted to be icon for illustration purposes. In some embodiments, the customer support option 314 may display a toll-free number, a clickable ‘Contact Us’ button, or a hyperlinked phone number configured to enable the user to request communication with the customer service interface.

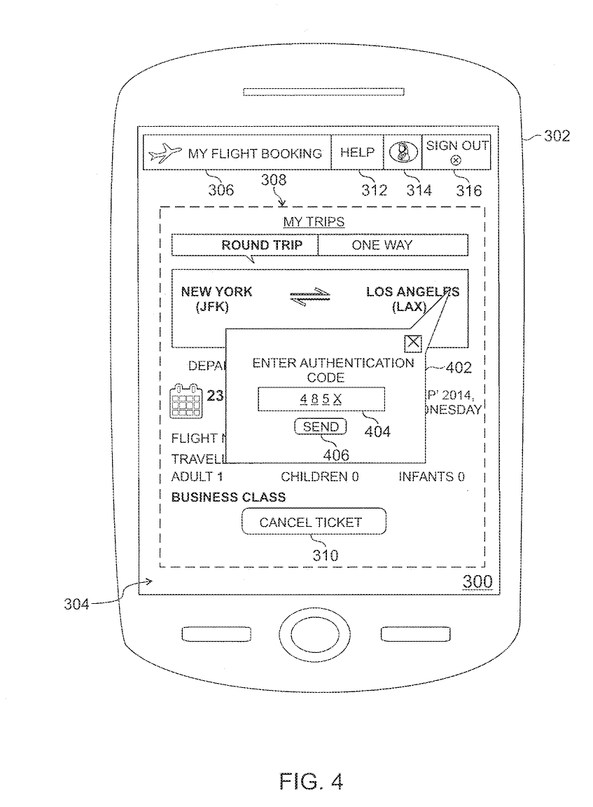

As explained with reference to FIG. 2, an apparatus, such as the apparatus 200 is configured to receive the request to communicate with the customer service interface made by the user during an on-going user interaction with an application, such as the application 304. Moreover, the apparatus 200 is configured to store information related to the user as well as previous user interactions (such as for example, the itinerary displayed in the device screen 300), which together configures the interaction context. Further, as explained with reference to FIG. 2, upon receiving the request for communication with the customer service interface, the apparatus 200 is caused to perform authentication of the user. In an embodiment, the apparatus 200 is caused to authenticate the user using authentication code as will be explained with reference to FIG. 4.

Referring now to FIG. 4, a second screenshot of the device screen 300 of the user device 302 is shown for illustrating an authentication of the user using an authentication code in accordance with an example embodiment. As explained with reference to FIG. 2, upon receiving a request for communication with the customer service interface, the apparatus 200 is caused to display a pop-up widget, such as a pop-up widget 402 on the device screen 300 during the on-going interaction with the application 304. The pop-up widget 402 displays the text ‘ENTER AUTHENTICATION CODE’ followed by a numeral entry field 404 to receive the authentication code as input from the user. Four user entry spaces are included in the numeral entry field 404 for enabling the user to manually enter the authentication code in form of a sequence of numerical digits. The user may use a virtual keyboard or a physical keyboard (not shown in FIG. 4) for providing the authentication code in form of digits. In an example scenario, the user is depicted to provide the first three digits as ‘4’, ‘8’ and ‘5’ respectively. The last digit entry is depicted to be shown as ‘x’ implying an ongoing digit entry.

Upon entering the fourth digit, the user may select a ‘Send’ button 406 displayed in the pop-up widget 402 to confirm the provisioning of authentication code.

As explained with reference to FIG. 2, the authentication code is designed to be unique to each user. A verification of the authentication code may be performed by the apparatus 200 by comparing the received authentication code with stored user authentication information as explained with reference to FIG. 2 and is not explained herein. The authentication code and its format are included herein for illustrative purposes and that the authentication code may include any combination of characters, numbers, special characters and the like. Moreover, a length of the authentication code may also vary from that depicted in FIG. 4.

As explained with reference to FIG. 2, the authentication code may have been provisioned by the user during his/her access to the application 304 and may be associated with a time-based expiration feature. In another embodiment, the authentication code may be generated by the application 304 and displayed to the user upon user access of the application 304 using other user credentials.

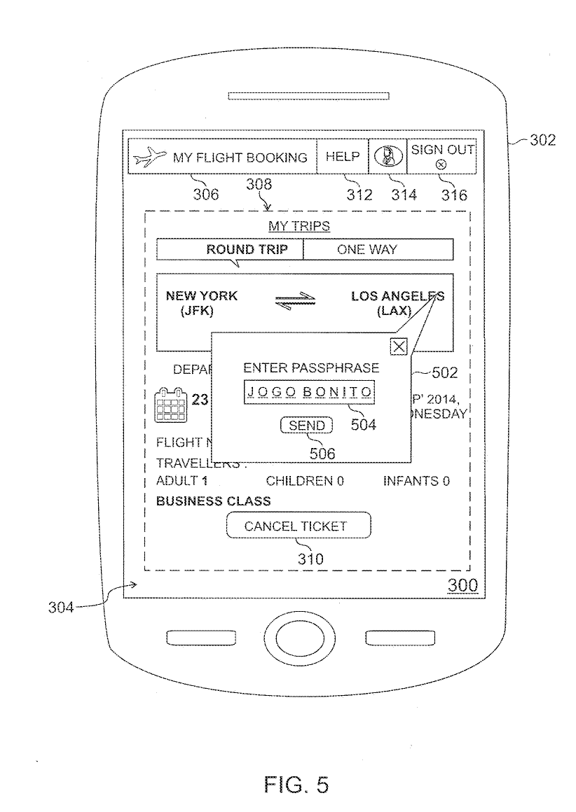

In some embodiments of the invention, the user, upon requesting communication with the customer service interface may be prompted to provide the authentication code using speech or DTMF means. For example, the user may verbally provide the authentication code (or manually punch in the keys) to provision the authentication code to the apparatus 200. As explained with reference to FIG. 2, the transmission of the authentication code to the apparatus 200 may be performed over a trusted network connection and/or by utilizing a secure Web service. In an embodiment, the apparatus 200 is caused to authenticate the user using a passphrase as will be explained with reference to FIG. 5.

Referring now to FIG. 5, a third screenshot of the device screen 300 of the user device 302 is shown for illustrating an authentication of the user using a passphrase in accordance with an example embodiment. As explained with reference to FIG. 2, upon receiving a request for communication with the customer service interface, the apparatus 200 is caused to display a pop-up widget, such as a pop-up widget 502 on the device screen 300 during the on-going interaction with the application 304. The pop-up widget 502 displays the text ‘ENTER PASSPHRASE’ followed by a text entry field 504 to receive the passphrase as input from the user.

A text entry line is included in the text entry field 504 for enabling the user to manually enter a passphrase (for example, any chosen sequence of characters, numbers, special characters or combinations thereof). The user may use a virtual keyboard or a physical keyboard (not shown in FIG. 5) for providing the passphrase. In an example scenario, the user is depicted to provide the passphrase as “JOGO BONITO” (meaning “beautiful game” in Portuguese). Upon entering the passphrase, the user may select a ‘Send’ button 506 displayed in the pop-up widget 502 to confirm the provisioning of authentication passphrase.

As explained with reference to FIG. 2, the passphrase is designed to be unique to each user. A verification of the passphrase may be performed by the apparatus 200 by comparing the received passphrase with stored user authentication information as explained with reference to FIG. 2 and is not explained herein. The passphrase and its format are included herein for illustrative purposes and that the passphrase may include any combination of characters, numbers, special characters and the like. Moreover, a length of the passphrase may also vary from that depicted in FIG. 5.

As explained with reference to FIG. 2, the passphrase may have been provisioned by the user during his/her access to the application 304 and may be associated with a time-based expiration feature. In another embodiment, the passphrase may be generated by the application 304 and displayed to the user upon user access of the application 304 using other user credentials.

In some embodiments of the invention, the user, upon requesting communication with the customer service interface may be prompted to provide the passphrase using speech or DTMF means. For example, the user may verbally provide the passphrase (or manually punch in the keys) to provision the passphrase to the apparatus 200.

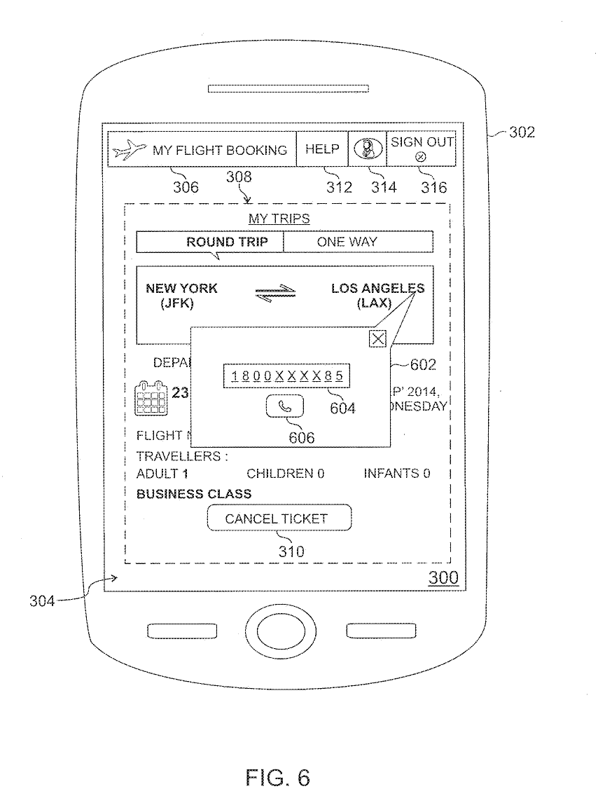

As explained with reference to FIG. 2, the transmission of the passphrase to the apparatus 200 may be performed over a trusted network connection and/or by utilizing a secure Web service. In an embodiment, the apparatus 200 is caused to authenticate the user using a DNIS number as will be explained with reference to FIG. 6.

Referring now to FIG. 6, a fourth screenshot of the device screen 300 of the user device 302 is shown for illustrating an authentication of the user using a DNIS number in accordance with an example embodiment. As explained with reference to FIG. 2, upon receiving a request for communication with the customer service interface, the apparatus 200 is caused to provide a unique DNIS number from among a pool of unique DNIS numbers to the user. The provisioning of the DNIS number to the user on the application 304 may be facilitated using the secure Web service. Accordingly, ten digit DNIS number is provided to the user in a pop-up widget 602 as depicted on the device screen 300 during the on-going interaction with the application 304. The pop-up widget 602 further displays a clickable button 604 for facilitating a dialing of the DNIS number.

As explained with reference to FIG. 2, the DNIS number is selected from a large pool of unique DNIS numbers and that a DNIS number is never used for two calls at the same time. Further, the selection of the DNIS number from among the pool of DNIS numbers may be performed in real time by the customer service interface or a telecommunications provider associated with the customer service interface. The selected DNIS number is then provided to the apparatus 200 for subsequent provision to the user. The dialing of the unique DNIS number by accessing the clickable button 604 by the user assists the apparatus 200 in uniquely identifying the user and hence eliminate the need to re-authenticate the user prior to the end of a configurable expiration period, on the basis that the user device 302 must still be in the control of the same user who authenticated themselves to the device application. If another user accidentally dials a DNIS after the end of the configurable expiration period, the apparatus 200 in assistance with the customer service interface may be caused to return an error because no request corresponding to that DNIS number was made for that user over the network.

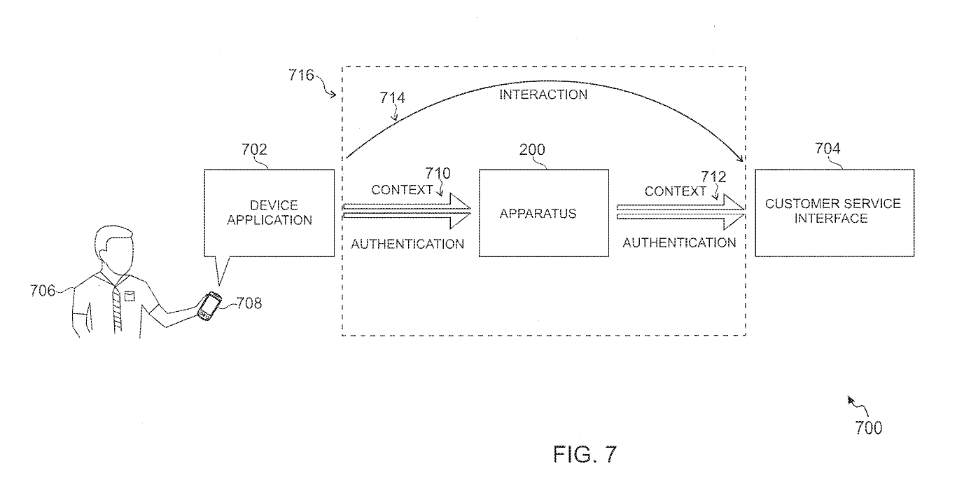

As explained with reference to FIG. 2, the authentication of the user by the apparatus 200 may be performed using other authentication mechanism than those explained with reference to FIGS. 3 to 6. For example, the authentication of the user by the apparatus 200 may be performed by using an outpulsed code, by initiating a VOIP call using a SIP enabled softphone, by using biometric data or by using gestures or audio tunes. Upon authenticating the user, the apparatus 200 is caused to facilitate communication between the user and the customer service interface and provision the interaction context to the customer service interface. The authentication of the user as well as the providing of the interaction context links the application 304 to a customer service interface, thereby enabling seamless continuation of a user experience. The linking of the application to the customer service interface is further explained with reference to FIG. 7.

FIG. 7 is a schematic diagram 700 showing an example linking of a device application 702 to a customer service interface 704 in accordance with an embodiment of the invention. The schematic diagram 700 depicts a user 706 associated with an electronic device 708. It is understood that the electronic device 708 is depicted to be a mobile phone of illustration purpose and that the electronic device 708 may be any electronic device from among a laptop, a tablet PC, a smartphone, and the like. The electronic device 708 is hereinafter referred to as user device 708. The user device 708 is depicted to include the device application 702 (such as the application 304 explained with reference to FIG. 3). The user 706 is configured to access the device application 702 using user credentials for authentication purpose and thereafter interact with the device application 702.

As explained with reference to FIG. 2, the apparatus 200 is caused to store the authentication information and information related to the one or more user interactions with an application, such as the device application 702. Occasionally, when the user 706 is unable to address a concern during an on-going user interaction with the device application 702, the user 706 may request communication with a customer service interface, such as the customer service interface 704 (for example, a human agent interface or an IVR based interface). Upon receiving the request for communication, the apparatus 200 is caused to authenticate the user 706 using one or more authentication mechanisms as explained with reference to FIGS. 2 to 6. The authentication of the user 706 is visually depicted in the schematic diagram 700 by block arrows 710 representing an exchange of information between the device application 702 and the apparatus 200.

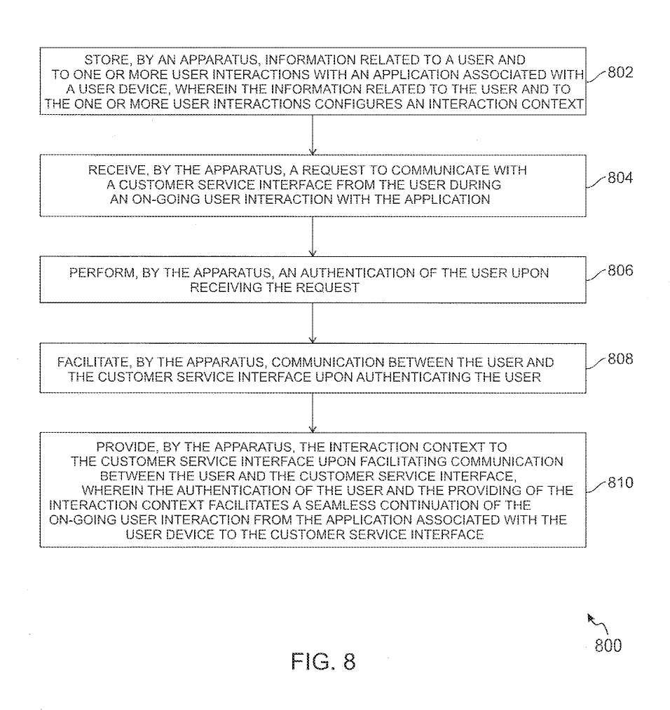

Upon a successful authentication of the user 706, the apparatus 200 is caused to facilitate an initiation of communication between the user 706 and the customer service interface 704 and provide the authentication information and the interaction context stored therein to the customer service interface 704, as depicted visually by block arrows 712. The authentication of the user and the providing of the interaction context facilitate a seamless continuation of the on-going user interaction from the device application 702 in the user device 708 to the customer service interface 704 (visually depicted by arrow 714). The apparatus 200 is thus caused to link the device application 702 to the customer service interface 704 to facilitate a seamless continuation of on-going user interaction from the device application 702 in the user device 708 to the customer service interface 704. The authentication of the user 706, the provisioning of the interaction context and subsequent communication between the user 706 and the customer service interface 704 is performed using a secure Web service 716 over a communication network, such as the network 110 explained with reference to FIG. 1. A method for linking a device application to a customer service interface is explained with reference to FIG. 8.

FIG. 8 is a flow diagram of a method 800 for linking a device application to a customer service interface in accordance with an embodiment of the invention. The method 800 depicted in the flow diagram may be executed by, for example, the apparatus 200 explained with reference to FIGS. 2 to 7. Operations of the flowchart, and combinations of operation in the flowchart, may be implemented by, for example, hardware, firmware, a processor, circuitry and/or a different device associated with the execution of software that includes one or more computer program instructions. The operations of the method 800 are described herein with help of the apparatus 200. It is noted that, the operations of the method 800 can be described and/or practiced by using an apparatus other than the apparatus 200. The method 800 starts at operation 802.

At operation 802, information related to a user and to one or more user interactions with an application associated with a user device is stored by an apparatus (such as for example, the apparatus 200 of FIG. 2). As explained with reference to FIG. 1, a user device (such as the smartphone 104 explained with reference to FIG. 1) may include a plurality of device applications, such as native mobile applications, Web-based applications, hybrid applications, and the like. A user may interact with such applications to perform various functions, such as those related to banking, retail purchases, travel reservations, networking, and the like.

In an embodiment of the invention, the information related to the user interaction with the application may include an interaction history corresponding to one or more past interactions between the user and the application, a last user transaction associated with the application and the like. In an illustrative example, if the application corresponds to a retail enterprise associated with a sale of a plurality of products, then user's past interaction history, such as past purchases, types of products purchased, frequency of purchase, and the like may be stored. Additionally, a last user transaction on the application may also be stored as information related to user interaction with the application.

In addition to storing the information related to user's interaction with the application, information related to the user is also stored. For example, user's personal information, such as name, mailing address, contact details, email accounts, social networking accounts, a number of user devices associated with the user, a type of the user devices associated with the user, user's device preferences, user's preference of an interaction mode for customer service interactions and the like, may also be stored.

Further, user authentication information associated with the application may be stored as information related to the user. For example, the user may login to the application using a login name and password; a unique authentication code (for example, code including three to five digits); a passphrase; a unique gesture; biometric data and/or a recorded audio tune. Such authentication information of the user may be stored as information related to the user. In an embodiment, stored information related to the user and to the one or more user interactions configures an interaction context (or more specifically, serve as contextual information for current and subsequent user interactions with the application).

At operation 804, a request to communicate with a customer service interface from the user during an on-going user interaction with the application is received by the apparatus (such as for example, the apparatus 200 of FIG. 2). As explained with reference to FIG. 1, applications in a user device include in-built features for assisting a user to obtain answer to a query or to resolve a concern without requiring external assistance.

In an embodiment of the invention, the application is configured to include one or more such self-assistance features associated with resolution of common issues encountered during interaction with the application. Examples of such self-assistance features include, but are not limited to online support forums, self-help widgets and FAQ sections. However, occasionally, such self-assistance features are unable to adequately address user concerns and the user may seek assistance from a customer support center (such as the customer support center 112) of FIG. 1.

More specifically, the user, upon being unable to resolve a concern during an on-going interaction with the application, may seek to communicate with a customer service interface, such as a human agent interface or an IVR based interface (which are referred to herein as a customer service interface) at the customer support center.

In an embodiment of the invention, the application may display a customer support clickable button (or an icon, for example a ‘Contact Us’ button), which upon being accessed may enable the user to transmit the request for communicating with the customer service interface.

In an embodiment of the invention, the application may display a hyperlinked toll-free number for enabling the user to transmit the request for communicating with the customer service interface. In an embodiment, the request for communicating with the customer service interface may be received using a secure Web service over a network, such as the network 110 explained with reference to FIG. 1.

At operation 806, an authentication of the user upon receiving the request is performed by the apparatus (such as for example, by the apparatus 200 explained with reference to FIG. 2). The authentication of the user may be performed using various authentication mechanisms such as those related to authentication code, passphrase, SIP enabled softphone, outpulsed code, DNIS number, gestures, audio tunes, biometric data and the like as explained with reference to FIGS. 2 to 6 and is not explained herein for sake of brevity.

At operation 808, a communication between the user and the customer service interface is facilitated by the apparatus (such as for example, by the apparatus 200 explained with reference to FIG. 2) upon authenticating the user. In an embodiment of the invention, the communication between the user and the customer service interface may be facilitated using a secure Web service over a network, such as the network 110 explained with reference to FIG. 1.

In an illustrative example, a user upon being unable to resolve a concern using in-built self-assistance features in the application may request communication with a customer service interface by accessing a customer support icon or clicking on a hyperlinked toll-free number corresponding to the customer service interface. Upon accessing a customer support icon or clicking on a hyperlinked toll-free number, the apparatus may receive the request and perform user authentication using one or more authentication mechanisms as explained above. Upon authenticating the user, the apparatus may connect the user, for example using the same toll-free number, to the customer service interface, thereby facilitating communication between the user and the customer service interface.

In embodiments of the invention involving native device applications, facilitating communication between the user and the customer service interface may include provisioning, post user-authentication, a widget requesting user permission to allow interaction with a customer service interface. In another illustrative example, a pop-up window displaying a textual request for allowing interaction with a customer service interface may be provisioned to the user on the native device application. The request for interaction may include, post user-authentication, a communication providing user with options to engage in an interaction with a customer service interface. For example, some users may opt conducting the interactions over a voice call (i.e. a speech medium preference) whereas some customers may opt to interact with customer service interfaces over chat (i.e. a messaging medium preference). Accordingly, the communication may be facilitated by conducting the interaction over a particular medium opted by the user.

For example, if the user opts speech medium, then a pop-up or a widget including text such as ‘Would you like our customer service representative to call you on your phone number ‘XX-XX-XXXXXX’ to discuss your requirements?’ may be provisioned to the user on the device application itself, thereby enabling the user to switch to preferred interaction mode for customer service interactions.

In another illustrative example, if the user opts for chat medium interaction, then a chat session can be started. Such session can be conducted in the native application itself. Accordingly, in some embodiments, the textual content in the pop-up window and/or widget may also suggest a day/time for scheduling the interaction. In an embodiment, a user response to the customer care interaction may be received (such as for example, by the apparatus 200 explained with reference to FIG. 2) prior to facilitating communication between the user and the customer service interface.

At operation 810, the interaction context is provided to the customer service interface upon authenticating the user by the apparatus (such as for example, the apparatus 200 of FIG. 2). More specifically, the apparatus is caused to provide the interaction context to the customer service interface upon facilitating communication between the user and the customer service interface. In an embodiment, at least one of the provisioning of the interaction context and subsequent communication between the user and the customer service interface is performed using a secure Web service over a communication network.

As a result of such authentication and the provisioning of the interaction context, the user does not have to provide details for self-identification (and/or authentication) and moreover, does not even to have to re-establish the interaction context for continuing the interaction, thereby rendering the continuation of the on-going user interaction from the application in the user device to the customer service interface to be seamless. More specifically, the authentication and the provisioning of the interaction context link the application on the user device to the customer service interface, and such a linking of the application to the customer service interface facilitates seamless traversal of the user's experience from the application to the customer service interface. A user experience may thereby be improved and satisfaction quotient of the user be increased, leading to reduced user churn.

Without in any way limiting the scope, interpretation, or application of the claims appearing below, advantages of one or more of the exemplary embodiments disclosed herein include linking of device applications to customer service interface, such as an IVR interface or a human interface (for example, a customer support representative). The techniques disclosed herein preclude the users from re-identifying himself or from re-establishing the interaction context upon traversing an interaction from an application in a user device to the customer service interface. This leads to a vastly enhanced user experience and obviates the cumbersome and frustrating reintroduction part of interacting with customer support services. Further, the various techniques facilitate uninterrupted communication between the user and the customer service center. The user saves time rather than having to answer questions for which he had provided details earlier during interaction with the application. Techniques disclosed herein facilitate back-end authentication and maintenance of interaction context and thereby bridge the gap between technologies solutions for self-service or assisted technology and applications on user devices. In some scenarios, the authentication and maintenance of interaction context may be extended between two channels, for example, online or Web channel to IVR interface, mobile interface to online channel, and the like.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Various embodiments of the present technology, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology.

Although various embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the invention that is set forth in the claims.

1. A computer-implemented method, comprising:
providing a processor executing instructions for storing information related to a user and to one or more user interactions with an application associated with a user device, wherein the information related to the user and to the one or more user interactions configures an interaction context;
said processor receiving a request to communicate with a customer service interface from the user during an on-going user interaction with the application;
said processor performing an authentication of the user upon receiving the request; and
said processor providing the interaction context to the customer service interface upon authenticating the user, wherein the authentication of the user and the providing of the interaction context facilitates a seamless continuation of the on-going user interaction from the application associated with the user device to the customer service interface.

2. The method of claim 1, further comprising:
said processor facilitating communication between the user and the customer service interface upon authenticating the user, wherein the interaction context is provided to the customer service interface upon facilitating communication between the user and the customer service interface.

3. The method of claim 1, wherein the information related to the one or more user interactions comprises at least one of an interaction history corresponding to one or more past interactions between the user and the application and a last user transaction associated with the application.

4. The method of claim 1, wherein the information related to the user comprises user authentication information associated with the application.

5. The method of claim 4, wherein performing authentication of the user comprises:
said processor requesting an authentication code from the user upon receiving the request;
said processor receiving the authentication code provided by the user; and
said processor comparing the authentication code to the user authentication information for a match, wherein the user is authenticated upon determining a presence of the match between the authentication code and the user authentication information.

6. The method of claim 4, wherein performing authentication of the user comprises:
said processor requesting a passphrase from the user upon receiving the request;
said processor receiving the passphrase provided by the user; and
said processor comparing the passphrase to the user authentication information for a match, wherein the user is authenticated upon determining a presence of the match between the passphrase and the user authentication information.

7. The method of claim 4, wherein performing authentication of the user comprises:
said processor providing a unique dialed number identification service (DNIS) number from among a pool of unique DNIS numbers to the user upon receiving the request, and wherein a dialing of the unique DNIS by the user is configured to facilitate authentication of the user.

8. The method of claim 4, wherein performing authentication of the user comprises:
said processor receiving an audio signal comprising dual tone multi-frequency (DTMF) corresponding to an outpulsed code, the outpulsed code configured by dialing a phone number corresponding to the customer service interface appended with a unique authentication code, wherein digits corresponding to the phone number and the unique authentication code are separated by one or more special characters; and
said processor comparing the unique authentication code in the audio signal to the user authentication information for a match, wherein the user is authenticated upon determining a presence of the match between the unique authentication code and the user authentication information.

9. The method of claim 4, wherein performing authentication of the user comprises:
said processor providing a phone number corresponding to the customer service interface; and
said processor receiving a voice over Internet protocol (VOIP) call from the user device based on the phone number, wherein a dialing of the phone number using VOIP call credentials by the user is configured to facilitate authentication of the user.

10. The method of claim 9, wherein the user device comprises an embedded session initiation protocol (SIP) enabled soft phone and, wherein the embedded SIP enabled phone is communicably associated with the application to facilitate VOIP calling of the phone number.

11. The method of claim 4, wherein performing the authentication corresponds to performing at least one of a biometric data based authentication, a gesture based authentication and an audio based authentication.

12. The method of claim 1, wherein the application corresponds to one of a native device application, a Web-based device application, and a hybrid device application.

13. The method of claim 1, wherein the application corresponds to a native mobile application.

14. The method of claim 1, wherein the application is configured to include one or more self-assistance features associated with resolution of common issues encountered during interaction with the application.

15. The method of claim 14, wherein a self-assistance feature from among the one or more self-assistance features corresponds to one of an online support forum, a self-help widget and a frequently asked questions (FAQ) section.

16. The method of claim 1, wherein the customer service interface corresponds to one of a human agent interface and an interactive voice response (IVR) based interface.

17. The method of claim 1, wherein at least one of performing the authentication of the user, the providing of the interaction context and subsequent communication between the user and the customer service interface is performed using a secure Web service over a communication network.

18. An apparatus comprising:
at least one processor; and
a memory having stored therein machine executable instructions, that when executed by the at least one processor, cause the apparatus to:
store information related to a user and to one or more user interactions with an application associated with a user device, wherein the information related to the user and to the one or more user interactions configures an interaction context;
receive a request to communicate with a customer service interface from the user during an on-going user interaction with the application;
perform an authentication of the user upon receiving the request; and
provide the interaction context to the customer service interface upon authenticating the user, wherein the authentication of the user and the providing of the interaction context facilitates a seamless continuation of the on-going user interaction from the application associated with the user device to the customer service interface.

19. The apparatus of claim 18, wherein the apparatus is further caused to:
facilitate communication between the user and the customer service interface upon authenticating the user, wherein the interaction context is provided to the customer service interface upon facilitating communication between the user and the customer service interface

20. The apparatus of claim 18, wherein the information related to the one or more user interactions comprises at least one of an interaction history corresponding to one or more past interactions between the user and the application and a last user transaction associated with the application.

21. The apparatus of claim 18, wherein the information related to the user comprises user authentication information associated with the application.

22. The apparatus of claim 21, wherein the apparatus is further caused to perform the authentication of the user by:
requesting an authentication code from the user upon receiving the request;
receiving the authentication code provided by the user; and
comparing the authentication code to the user authentication information for a match, wherein the user is authenticated upon determining a presence of the match between the authentication code and the user authentication information.

23. The apparatus of claim 21, wherein the apparatus is further caused to perform the authentication of the user by:
requesting a passphrase from the user upon receiving the request;
receiving the passphrase provided by the user; and
comparing the passphrase to the user authentication information for a match, wherein the user is authenticated upon determining a presence of the match between the passphrase and the user authentication information.

24. The apparatus of claim 21, wherein the apparatus is further caused to:
providing a unique dialed number identification service (DNIS) number from among a pool of unique DNIS numbers to the user upon receiving the request, and wherein a dialing of the unique DNIS by the user is configured to facilitate authentication of the user.

25. The apparatus of claim 21, wherein the apparatus is further caused to perform the authentication of the user by:
receiving an audio signal comprising dual tone multi-frequency (DTMF) corresponding to an outpulsed code, the outpulsed code configured by dialing a phone number corresponding to the customer service interface appended with a unique authentication code, wherein digits corresponding to the phone number and the unique authentication code are separated by one or more special characters; and
comparing the unique authentication code in the audio signal to the user authentication information for a match, wherein the user is authenticated upon determining a presence of the match between the unique authentication code and the user authentication information.

26. The apparatus of claim 21, wherein the apparatus is further caused to perform the authentication of the user by:
providing a phone number corresponding to the customer service interface; and
receiving a voice over Internet protocol (VOIP) call from the user device based on the phone number, wherein a dialing of the phone number using VOIP call credentials by the user is configured to facilitate authentication of the user.

27. The apparatus of claim 26, wherein the user device comprises an embedded session initiation protocol (SIP) enabled soft phone and, wherein the embedded SIP enabled phone is communicably associated with the application to facilitate VOIP calling of the phone number.

28. The apparatus of claim 21, wherein performing the authentication corresponds to performing at least one of a biometric data based authentication, a gesture based authentication and an audio based authentication.

29. The apparatus of claim 18, wherein the application corresponds to one of a native device application, a Web-based device application, and a hybrid device application.

30. The apparatus of claim 18, wherein the application corresponds to a native mobile application.

31. The apparatus of claim 18, wherein the application is configured to include one or more self-assistance features associated with resolution of common issues encountered during interaction with the application.

32. The apparatus of claim 31, wherein a self-assistance feature from among the one or more self-assistance features corresponds to one of an online support forum, a self-help widget and a frequently asked questions (FAQ) section.

33. The apparatus of claim 18, wherein the customer service interface corresponds to one of a human agent interface and an interactive voice response (IVR) based interface.

34. The apparatus of claim 18, wherein at least one of performing the authentication of the user, the providing of the interaction context and subsequent communication between the user and the customer service interface is performed using a secure Web service over a communication network.
